(19) United States
(12) Patent Application Publication
(10) Pub. No.: US 2025/0052359 A1
(43) Pub. Date: Feb. 13, 2025

(54) BASE STRUCTURE OF COOLING FAN AND MANUFACTURING METHOD THEREOF

(71) Applicant: F&P PRECISION CO., LTD., Taipei City (TW)

(72) Inventor: PING-LING WANG, Taipei City (TW)

(21) Appl. No.: 18/790,314

(22) Filed: Jul. 31, 2024

(30) Foreign Application Priority Data
Aug. 7, 2023 (TW) 112129530

(51) Int. Cl. F16M 1/04

(52) U.S. Cl. CPC F16M 1/04

(57) ABSTRACT

A base structure of a cooling fan and a manufacturing method of the base structure are provided. The base structure includes a bearing, a shaft sleeve and a base. The bearing defines therein a first cylindrical cavity for receiving a shaft of the cooling fan. The shaft sleeve is made of a first material and defines therein a second cylindrical cavity. The shaft sleeve includes a protrusion part and a first engagement structure arranged at a first end and a second end of the shaft sleeve, respectively. The base is made of a second material and includes a second engagement structure. The second engagement structure is interlocked with the first engagement structure since the second engagement structure is integrally formed with the base. The first material has a greater rigidity than the second material.

### FIELD OF THE INVENTION

The present disclosure relates to a base structure of a cooling fan and a manufacturing method thereof, and particularly to a base structure applied to a cooling fan used in an electronic product and its manufacturing method.

### BACKGROUND OF THE INVENTION

Nowadays, portable electronic products have rapidly increasing computing power but much compact size. Naturally, the electronic products require higher heat dissipation performance. Therefore, portable electronic products (such as notebook computers) usually need to use a cooling fan to meet heat dissipation requirements. In order to obtain a cooling fan assembly which is small and thin enough, many requirements have to be met, involving structure designs of its base, bearing and shaft sleeve and techniques applied to the manufacturing and assembling method. The consideration is to further reduce production costs and simplify production processes while maintaining structural strength and durability. Unfortunately, the current structure designs and the known techniques applied to the manufacturing and assembling methods of the cooling fan assemblies cannot meet coming needs. It is desired to develop new technical means to improve the structure and methods.

### SUMMARY OF THE INVENTION

An aspect of the present disclosure provides a base structure of a cooling fan. The cooling fan includes a bearing, a shaft sleeve and a base. The bearing defines therein a first cylindrical cavity for receiving a shaft of the cooling fan. The shaft sleeve is made of a first material and defines therein a second cylindrical cavity having a first opening and a second opening at a first end and a second end of the shaft sleeve, respectively. The shaft sleeve includes a protrusion part arranged at the first end of the shaft sleeve and protruding from an inner surface of the shaft sleeve toward the second cylindrical cavity, wherein the bearing is inserted into the shaft sleeve through the second opening and is stopped by the protrusion part. The shaft sleeve includes a first engagement structure provided at the second end of the shaft sleeve. The base is made of a second material and includes a second engagement structure. The second engagement structure is interlocked with the first engagement structure since the second engagement structure is integrally formed with the base, thereby restricting the bearing from moving with respect to the base. The first material has a greater rigidity than the second material

In an embodiment, the bearing is an oil-impregnated bearing.

In an embodiment, the bearing is a self-lubricating bearing.

In an embodiment, the base is formed by injecting the second material into a mold in an injection molding process. An accommodation room is provided in the mold for accommodating the first engagement structure. The second engagement structure is formed and interlocked with the first engagement structure in the injection molding process of forming the base.

In an embodiment, the first material is a metal material of copper, aluminum, steel or metal alloy, and the second material is a plastic material.

In an embodiment, the first material has the greater rigidity than the second material when the cooling fan operates and the shaft sleeve is located within a working temperature range of 60-100° C.

In an embodiment, the first material has a higher deformation resistance than the second material when the cooling fan operates and the shaft sleeve is located within the working temperature range of 60-100° C.

In an embodiment, the first engagement structure is implemented by at least one projecting piece having a main part extending along a circumferential direction of the shaft sleeve. The first engagement structure is engaged with the second engagement structure to restrict the first engagement structure from moving with respect to the second engagement structure along a lengthwise direction of the shaft.

In an embodiment, the first engagement structure is provided by forming at least one trench on the shaft sleeve, and the trench has a main hole extending along a circumferential direction of the shaft sleeve. The first engagement structure is engaged with the second engagement structure to restrict the first engagement structure from moving with respect to the second engagement structure along a lengthwise direction of the shaft.

In an embodiment, the first engagement structure is implemented by annular grooves, knurled patterns or mesh patterns around an outer surface of the shaft sleeve. The first engagement structure is engaged with the second engagement structure to restrict the first engagement structure from moving with respect to the second engagement structure along a lengthwise direction of the shaft.

In an embodiment, the first engagement structure is implemented by at least one internal annular cutting portion formed on the inner surface of the shaft sleeve at the second end. The internal annular cutting portion has an annular slant surface with a first circular boundary surrounding the second opening and a second circular boundary away from the second opening. The diameter of the first circular boundary is smaller than a diameter of the second circular boundary. The first engagement structure is engaged with the second engagement structure to restrict the first engagement structure from moving with respect to the second engagement structure along a lengthwise direction of the shaft.

An aspect of the present disclosure provides a manufacturing method of a base structure of a cooling fan. A bearing defining therein a first cylindrical cavity is provided. A shaft of the cooling fan is inserted into the first cylindrical cavity. A shaft sleeve made of a first material and defining therein a second cylindrical cavity is provided. The second cylindrical cavity has a first opening and a second opening at a first end and a second end of the shaft sleeve, respectively. The shaft sleeve has a protrusion part arranged at the first end of the shaft sleeve and protruding from an inner surface of the shaft sleeve toward the second cylindrical cavity. The shaft sleeve has a first engagement structure provided at the second end of the shaft sleeve. The bearing is inserted into the shaft sleeve through the second opening till reaching the protrusion part. The shaft sleeve is put in a mold to make the first engagement structure of the shaft sleeve located in an accommodation room defined in the mold. An injection molding process is performed to form a base with a second engagement structure by injecting a second material into the mold. The second engagement structure is interlocked with the first engagement structure since the second engagement structure is integrally formed with the base in the injection molding process, thereby restricting the shaft sleeve from moving with respect to the base.

In an embodiment, the manufacturing method further includes a step of using an internal turning tool to cut the inner surface of the shaft sleeve at the second end to form an internal annular cutting portion as the first engagement structure. The internal annular cutting portion has an annular slant surface with a first circular boundary surrounding the second opening and a second circular boundary away from the second opening. A diameter of the first circular boundary is smaller than a diameter of the second circular boundary. The first engagement structure is engaged with the second engagement structure to restrict the first engagement structure from moving with respect to the second engagement structure along a lengthwise direction of the shaft.

### BRIEF DESCRIPTION OF THE DRAWINGS

The advantages of the present disclosure will become more readily apparent to those ordinarily skilled in the art after reviewing the following detailed description and accompanying drawings, in which:

FIG. 1 is a cross-sectional view of a base structure of a cooling fan according to an embodiment of the present disclosure.

FIGS. 2A and 2B are cross-sectional views showing a mold, in an open state and a closed state, respectively, for manufacturing the base structure of the cooling fan according to the present disclosure.

FIG. 3A is a schematic diagram showing details of individual components of the base structure in FIG. 1.

FIG. 3B is a schematic diagram showing cross-sections of individual components of the base structure in FIG. 1.

FIGS. 4A-4G are schematic diagrams showing variations of the first engagement structure according to embodiments of the present disclosure.

FIGS. 5A-5C are schematic diagrams illustrating a base structure and its manufacturing method according to another embodiment of the present disclosure.

### DETAILED DESCRIPTION OF PREFERRED EMBODIMENTS

The present disclosure will now be described more specifically with reference to the following embodiments. It is to be noted that the following descriptions of preferred embodiments of this invention are presented herein for purpose of illustration and description only. It is not intended to be exhaustive or to be limited to the precise form disclosed. The figures do not necessarily reflect the actual structure, shape, size or dimension of components being illustrated. Modifications or adjustments of the structure, shape, size or dimension of the components should be covered in the practicable scope of the present disclosure when such changes do not deviate from the concepts of the present disclosure.

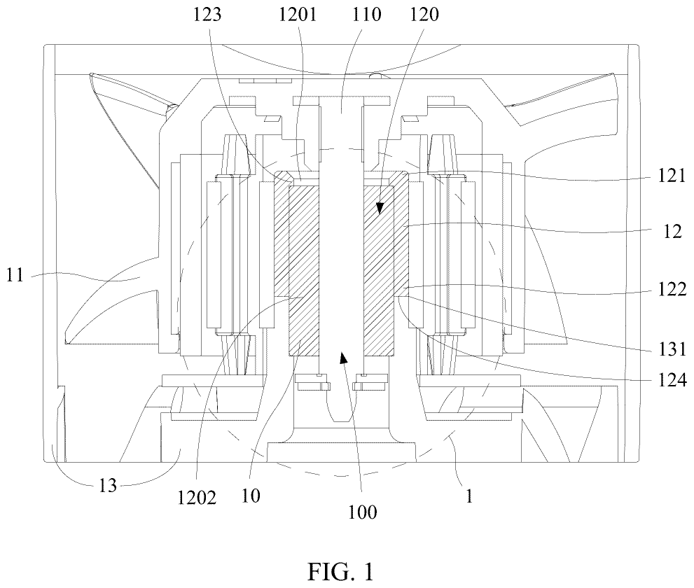

Please refer to FIG. 1, which is a cross-sectional view of a base structure of a cooling fan according to an embodiment of the present disclosure. The base structure 1 mainly includes a bearing 10, a shaft sleeve 12 and a base 13. The bearing 10 defines therein a first cylindrical cavity 100 for receiving a shaft 110 of a cooling fan 11. The bearing 10 could be an oil-impregnated bearing, particularly a self-lubricating bearing, which has lubricant impregnated within the bearing 10 and additional external lubricant is not required. One type of the self-lubricating bearing contains metal material and specific self-lubricating substance. For example, the metal material could be steel or copper alloy having better strength and supportability. The self-lubricating substance could be a solid lubricant embedded within a material matrix. Another type of the self-lubricating substance is a polymer or a composite material. These materials have good self-lubricating performance. Common self-lubricating materials include solid lubricants such as solid lubricant particles (e.g. polytetrafluorethylene (PTFE), lead, etc.) or solid lubricant additives and polymer materials or polymer-based materials. The material can release the lubricant when the bearing is operating, thus reducing friction and wear during the operation of the bearing. Hence, the self-lubricating bearing can work well in a high temperature environment.

The shaft sleeve 12 is made of a first material, and defines therein a second cylindrical cavity 120. The second cylindrical cavity 120 has a first opening 1201 and a second opening 1202 at a first end 121 and a second end 122 of the shaft sleeve 12, respectively. The shaft sleeve 12 has a protrusion part 123 arranged at the first end 121 and protruding from the inner surface of the shaft sleeve 12 toward the inside of the second cylindrical cavity 120. The shaft sleeve 12 receives the bearing 10 in the second cylindrical cavity 120 through the second opening 1202. The bearing 10 is stopped by the protrusion part 123 when reaching the first end 121 of the shaft sleeve 12. Further, the shaft sleeve 12 has a first engagement structure 124 at the second end 122. Details and variations of the first engagement structure 124 will be given in the following embodiments.

In an embodiment of the present disclosure, the base 13 includes a second engagement structure 131. The base 13 is made of a second material. The second engagement structure 131 which is also made of the second material is formed and fixed to the first engagement structure 124 immediately after the second engagement structure 131 is integrally formed with the base 13. The first engagement structure 124 and the second engagement structure 131 are coupled to each other to restrict the relative motion of the shaft sleeve 12 with respect to the base 13. The first material and the second material could be selected based on that the rigidity of the first material is greater than the rigidity of the second material within a working temperature range. A better condition is that the first material could have a higher deformation resistance than the second material at high temperature. The working temperature range is defined as the ambient temperature at which the shaft sleeve 12 is located when the cooling fan 11 operates. Within the working temperature range, the first material has a higher deformation resistance than the second material. By this way, the shaft sleeve 12 made of the first material will not deform due to the high temperature caused by the operation of the motor of the cooling fan 11. Further, it is better to select the first material having a greater heat dissipation capacity than the second material. Good heat dissipation performance of the shaft sleeve 12 can reduce the heat transferring to the base 13 and prevent from the base 13 from overheating and deforming. For example, the working temperature range of the shaft sleeve 12 is 60-100° C. when the motor (not shown) of the cooling fan 11 runs. The first material could be a metal material such as copper, aluminum, stainless steel and alloy, and the second material could be a plastic material. By this way, the shaft sleeve 12 made of the metal material does not deform due to the high temperature caused by the operation of the motor of the cooling fan 11. Also, the metal shaft sleeve 12 is advantageous to heat dissipation so that the plastic base 13 does not overheat and deform.

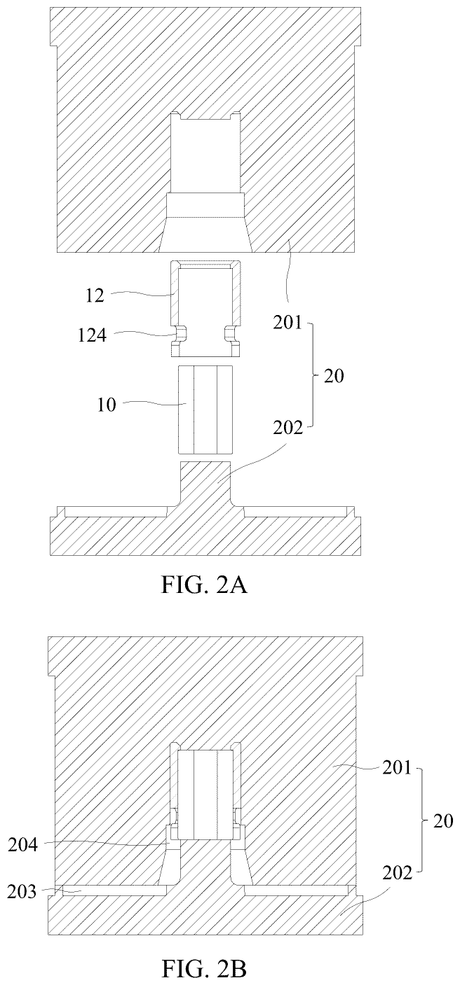

Please refer to FIGS. 2A and 2B, which are cross-sectional views showing a mold, in an open state and a closed state, respectively, for manufacturing the base structure of the cooling fan according to the present disclosure. The mold 20 is used to form the base 13 by injection molding. From FIG. 2A, it is shown that the mold 20 substantially consists of an upper half 201 and a lower half 202. As shown in FIG. 2B, there is a main cavity 203 and an accommodation room 204 in the combined mold 20. The accommodation room 204 receives the first engagement structure 124 of the shaft sleeve 12. Then, the base 13 together with the second engagement structure 131 is formed in the main cavity 203 by injection molding. Through the injection molding process, the second engagement structure 131 is formed in a way that the first engagement structure 124 and the second engagement structure 131 have interlocking shapes. The second engagement structure 131 is formed and fixed to the first engagement structure 124 as soon as the injection molding process for forming the base 13 is completed. Accordingly, the manufacturing method of the base structure 1 of the cooling fan 11 includes the following steps. At first, a bearing 10 defining therein a first cylindrical cavity 100 is provided. Then, a shaft 110 of the cooling fan 11 is inserted into the first cylindrical cavity 100. Further, a shaft sleeve 12 made of a first material and defining a second cylindrical cavity 120 is provided. The second cylindrical cavity 120 has a first opening 1201 and a second opening 1202 at a first end 121 and a second end 122 of the shaft sleeve 12, respectively. The shaft sleeve 12 has a protrusion part 123 arranged at the first end 121 and protruding from the inner surface of the shaft sleeve 12 toward the inside of the second cylindrical cavity 120. The shaft sleeve 12 has a first engagement structure 124 at the second end 122. Then, the bearing 10 together with the shaft 110 is inserted into the shaft sleeve 12 through the second opening 1202. The bearing 10 is stopped by the protrusion part 123 when reaching the first end 121. The bearing 10 and shaft sleeve 12 are put in the mold 20 while positioning the first engagement structure 124 in the accommodation room 204. Subsequently, an injection molding process is performed to form the base 13 by injecting a second material into the mold 20. In the same injection molding process for forming the base 13, the second engagement structure 131 is formed and fixed to the first engagement structure 124. The first engagement structure 124 and the second engagement structure 131 are coupled to each other to restrict the shaft sleeve 12 from moving with respect to the base 13 (e.g. along the lengthwise direction of the shaft 110).

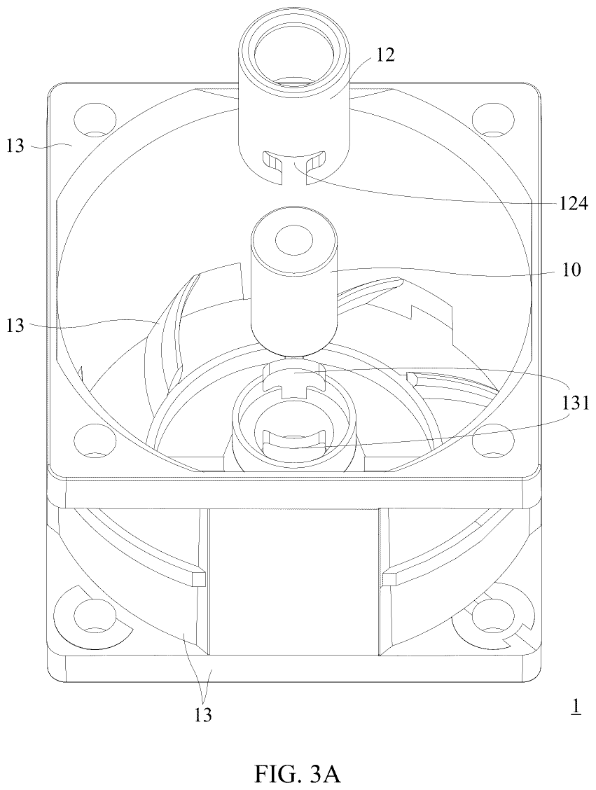

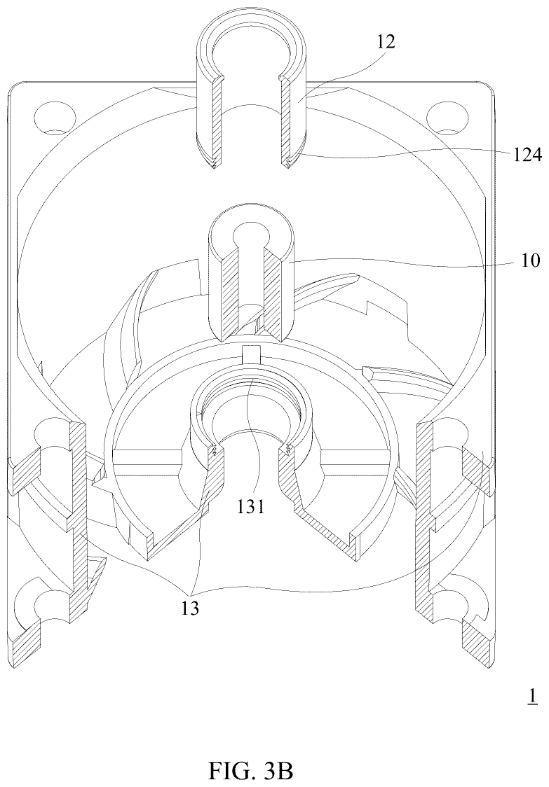

Please refer to FIGS. 3A and 3B which show details of individual components (e.g. the bearing 10, the shaft sleeve 12, the base 13, the first engagement structure 124 and the second engagement structure 131) of the base structure 1 in FIG. 1. FIG. 3A shows separated components. It is to be noted that the second engagement structure 131 is formed and directly coupled to the first engagement structure 124 of the shaft sleeve 12 in the injection molding process of the base 13. Therefore, the separated components are shown in this diagram for illustration purposes. In fact, the separation does not exist and the components are not provided separately after the injection molding process of the base 13.

FIG. 3B shows cross-sections of individual components of the base structure. In this diagram, the first engagement structure 124 and the second engagement structure 131 are implemented with other interlocking shapes, i.e. parallel annular grooves. According to the present disclosure, the first engagement structure 124 and the second engagement structure 131 may have variations, and examples are given below.

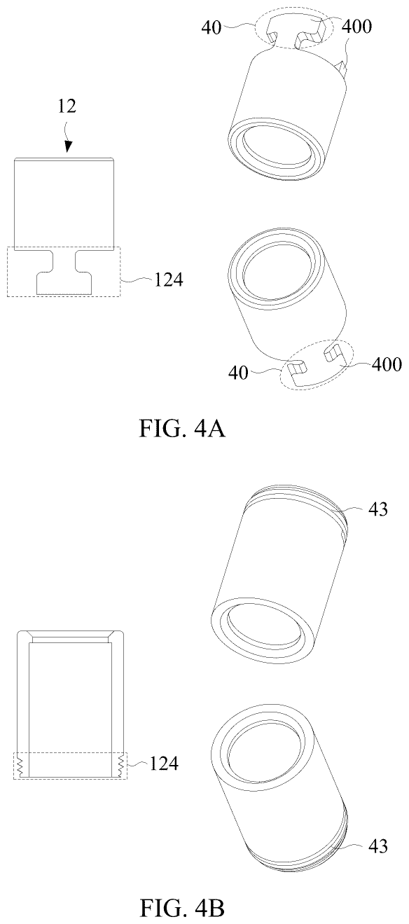

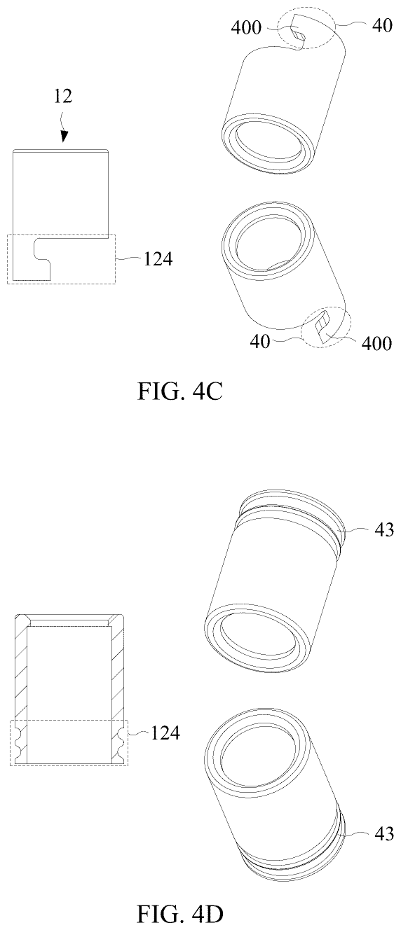

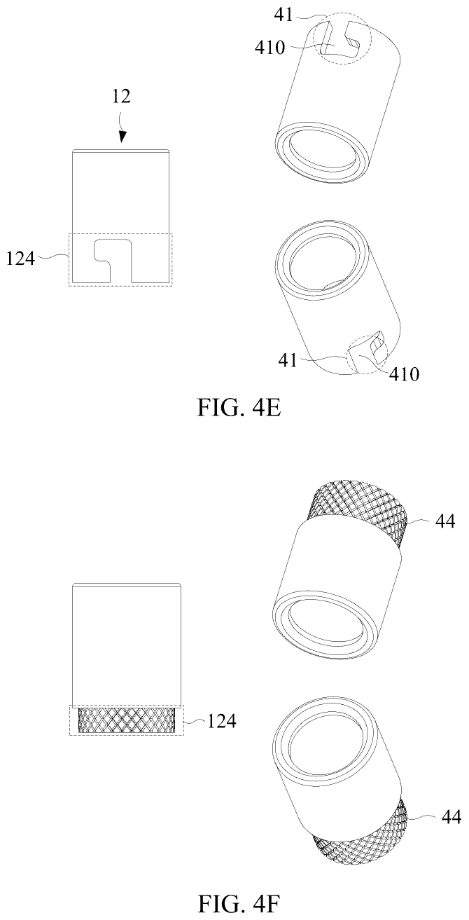

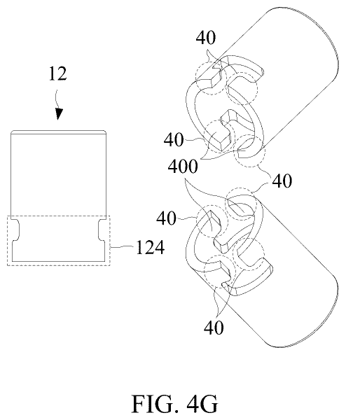

Please refer to FIGS. 4A˜4G, which are schematic diagrams showing variations of the first engagement structure according to embodiments of present disclosure. The first engagement structure 124 in FIG. 4A, 4C, 4E or 4G is obtained by forming a large-area projecting piece 40 or trench 41 on the shaft sleeve 12. Observing from different viewpoints in the diagrams, the projecting piece 40 or the trench 41 has a main part 400 or a main hole 410 extending along a circumferential direction of the shaft sleeve 12 at the second end 122 and having a greater arc length along the circumferential direction. The greater area of the main part 400 or the main hole 410 make the first engagement structure 124 firmly interlocked and engaged with the second engagement structure 131 formed by injection molding, thereby restricting the shaft sleeve 12 from moving with respect to the base 13 (e.g. along the lengthwise direction of the shaft 110). The first engagement structure 124 in FIG. 4B, 4D or 4F is obtained by forming a patterned surface around the outer surface of the shaft sleeve 12 at the second end 122. For example, the first engagement structure 124 could include annular grooves 43 as shown in FIG. 4B or 4D, or include knurled patterns or mesh patterns 44 as shown in FIG. 4F. The present disclosure does not limit the size of and the space between the grooves 43 or the mesh patterns 44. The tangent vector and the centripetal vector of each annular groove is perpendicular to the central line or the lengthwise direction (not shown) of the shaft sleeve 12. Therefore, the second engagement structure 131 obtained from the injection molding can be firmly interlocked and engaged with the first engagement structure 124 and has sufficient strength, thereby restricting the shaft sleeve 12 from moving with respect to the base 13 (e.g. along the lengthwise direction of the shaft 110).

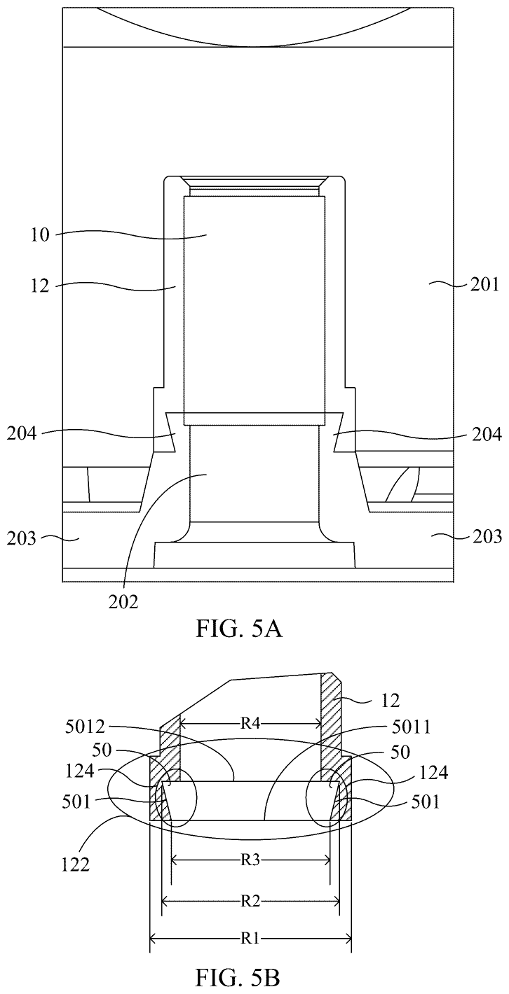

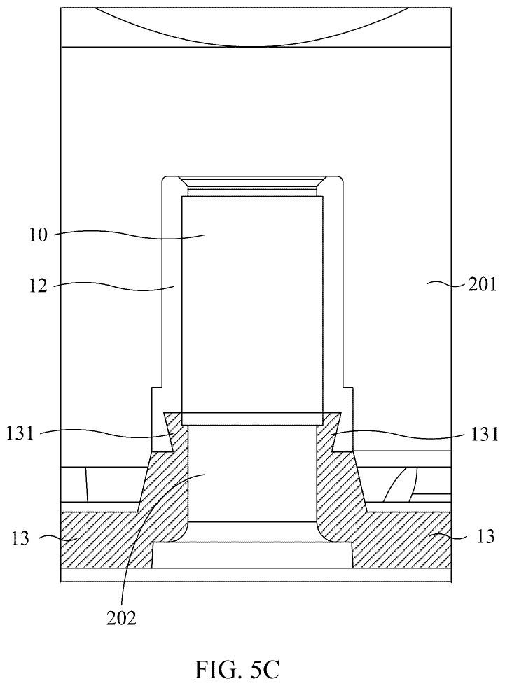

Please refer to FIG. 5A, which shows another embodiment of the first engagement structure 124 of the shaft sleeve 12 according to the present disclosure. This diagram depicts the bearing 10, the shaft sleeve 12, the upper half 201 of the mold 20, the lower half 202 of the mold 20, the main cavity 203 and the accommodation room 204. The accommodation room 204 accommodates the first engagement structure 124 of the shaft sleeve 12.

Please refer to FIG. 5B, which is a cross-sectional view focusing on the second end 122 of the shaft sleeve 12 of FIG. 5A. In the embodiment, the first engagement structure 124 is formed on the inner surface of the side wall, which defines the second cylindrical cavity 120, of the shaft sleeve 12 at the second end 122. The first engagement structure 124 may be formed by using an internal turning tool to cut the inner surface of the shaft sleeve 12 via the second cylindrical cavity 120 to form an internal annular cutting portion 50. From the cross-sectional view, it is observed that the internal annular cutting portion 50 has an annular slant surface 501. The annular slant surface 501 has a first circular boundary 5011 surrounding the second opening 1202 and a second circular boundary 5012 away from the second opening 1202. The diameter of the first circular boundary 5011 is smaller than the diameter of the second circular boundary 5012. For example, the shaft sleeve 12 has an outer diameter R1 of 10 mm and an inner diameter R4 of 7 mm. The diameter R2 (or called the bottom cutting diameter) of the second opening 1202 (i.e. the diameter of the first circular boundary 5011 of the annular cutting portion 50 surrounding the second opening 1202) is 9 mm and the diameter R3 (or called the top cutting diameter) of the second circular boundary 5012 of the annular cutting portion 50 away from the second opening 1202 is 8 mm.

As shown in FIG. 5C, while using the main cavity 203 in the combined mold 20 to form the base 13 via injection molding, the shape of the first engagement structure 124 and the mold 20 determines the shape of the second engagement structure 131. The second engagement structure 131 is integrally formed with the base 13 and fixed to the first engagement structure 124. Concretely speaking, the manufacturing method of the base structure of the cooling fan includes the following steps. At first, a bearing 10 defining therein a first cylindrical cavity 100 is provided. Then, a shaft sleeve 12 made of a first material (e.g. copper, aluminum, steel, metal alloy) and defining therein a second cylindrical cavity 120 is provided. The second cylindrical cavity 120 has a first opening 1201 and a second opening 1202 at a first end 121 and a second end 122 of the shaft sleeve 12, respectively. The shaft sleeve 12 has a protrusion part 123 arranged at the first end 121 and protruding from the inner surface of the shaft sleeve 12 toward the inside of the second cylindrical cavity 120. The shaft sleeve 12 has a first engagement structure 124 at the second end 122. Then, the bearing 10 (with or without a shaft 110 of the cooling fan 11) is inserted into the shaft sleeve 12 through the second opening 1202. The bearing 10 is stopped by the protrusion part 123 when reaching the first end 121. The bearing 10 and shaft sleeve 12 are put in the mold 20 while positioning the first engagement structure 124 in the accommodation room 204. Subsequently, the base 13 is formed by injecting a second material (e.g. plastic) into the mold 20 vin an injection molding process. In the same injection molding process for forming the base 13, the second engagement structure 131 is fixed to the first engagement structure 124 immediately after the second engagement structure 131 is integrally formed with the base 13. The first engagement structure 124 and the second engagement structure 131 are coupled to each other to restrict the shaft sleeve 12 from moving with respect to the base 13 (e.g. along the lengthwise direction of the shaft 110).

In the embodiment with reference to FIG. 5C, the first engagement structure 124 is provided on the inner surface of the sidewall, which defines the second cylindrical cavity 120, at the second end 122 of the shaft sleeve 12. Thus, the second material is injected and then flows into the space between the shaft sleeve 12 and the lower half 202 of the mold 20 through the second cylindrical cavity 120 to form the second engagement structure 131. The second engagement structure 131 is firmly engaged with the first engagement structure 124 and has sufficient strength, thereby restricting the shaft sleeve 12 from moving with respect to the base 13 (e.g. along the lengthwise direction of the shaft 110). Furthermore, the base structure 1 of the present disclosure can adopt both the engagement structure (provided on the inner surface of the shaft sleeve 12) in this embodiment and the engagement structure (provided on the outer surface of the shaft sleeve 12) with reference to FIG. 4B, 4D or 4F to form the first engagement structure 124 with double engagement effect. By this way, the grooves are provided on both the inner surface and the outer surface of the shaft sleeve 12, and the second engagement structure 131 formed by the injection molding process can catch both surfaces of the shaft sleeve 12 from different directions to enhance the engagement between the shaft sleeve 12 and the base 13, thereby restricting the shaft sleeve 12 from moving in relative to the base (e.g. along the lengthwise direction of the shaft 110). In addition to combining the features of the engagement structure shown in FIG. 5A, 5B or 5C and the engagement structure shown in FIG. 4B, 4D or 4F to provide the first engagement structure 124, it is also applicable to further introducing the features of the engagement structure shown in FIG. 4A, 4C, 4E or 4G, i.e. using a large-area projecting piece 40 or trench 41 on the shaft sleeve 12, into the first engagement structure 124 with combined features. By this way, when the base 13 is formed by injecting the second material (e.g. plastic) into the mold 20, the second engagement structure 131 catching the first engagement structure 124 from three different directions is also formed. Thus, the engagement between the shaft sleeve 12 and the base 13 is further enhanced, thereby rest restricting the shaft sleeve 12 from moving in relative to the base 13 (e.g. along the lengthwise direction of the shaft 110).

In conclusion, the present disclosure provides a simplified manufacturing method for forming the base structure with lower production cost, while maintaining satisfied structure strength and durability.

While the disclosure has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A base structure of a cooling fan, comprising:
a bearing, defining therein a first cylindrical cavity for receiving a shaft of the cooling fan;
a shaft sleeve made of a first material and defining therein a second cylindrical cavity having a first opening and a second opening at a first end and a second end of the shaft sleeve, respectively, the shaft sleeve further comprising:
a protrusion part arranged at the first end of the shaft sleeve and protruding from an inner surface of the shaft sleeve toward the second cylindrical cavity, wherein the bearing is inserted into the shaft sleeve through the second opening and is stopped by the protrusion part; and
a first engagement structure provided at the second end of the shaft sleeve; and
a base made of a second material and comprising a second engagement structure, wherein the second engagement structure is interlocked with the first engagement structure since the second engagement structure is integrally formed with the base, thereby restricting the bearing from moving with respect to the base,
wherein the first material has a greater rigidity than the second material.

2. The base structure according to claim 1, wherein the bearing is an oil-impregnated bearing.

3. The base structure according to claim 2, wherein the bearing is a self-lubricating bearing.

4. The base structure according to claim 1, wherein the base is formed by injecting the second material into a mold in an injection molding process, and an accommodation room is provided in the mold for accommodating the first engagement structure, wherein the second engagement structure is formed and interlocked with the first engagement structure in the injection molding process for forming the base.

5. The base structure according to claim 1, wherein the first material is a metal material of copper, aluminum, steel or metal alloy, and the second material is a plastic material.

6. The base structure according to claim 1, wherein the first material has the greater rigidity than the second material when the cooling fan operates and the shaft sleeve is located within a working temperature range of 60-100° C.

7. The base structure according to claim 6, wherein the first material has a higher deformation resistance than the second material when the cooling fan operates and the shaft sleeve is located within the working temperature range of 60-100° C.

8. The base structure according to claim 1, wherein the first engagement structure is implemented by at least one projecting piece having a main part extending along a circumferential direction of the shaft sleeve, the first engagement structure being engaged with the second engagement structure to restrict the first engagement structure from moving with respect to the second engagement structure along a lengthwise direction of the shaft.

9. The base structure according to claim 1, wherein the first engagement structure is provided by forming at least one trench on the shaft sleeve, and the trench has a main hole extending along a circumferential direction of the shaft sleeve, the first engagement structure being engaged with the second engagement structure to restrict the first engagement structure from moving with respect to the second engagement structure along a lengthwise direction of the shaft.

10. The base structure according to claim 1, wherein the first engagement structure is implemented by annular grooves, knurled patterns or mesh patterns around an outer surface of the shaft sleeve, the first engagement structure being engaged with the second engagement structure to restrict the first engagement structure from moving with respect to the second engagement structure along a lengthwise direction of the shaft.

11. The base structure according to claim 1, wherein the first engagement structure is implemented by at least one internal annular cutting portion formed on the inner surface of the shaft sleeve at the second end, the internal annular cutting portion having an annular slant surface with a first circular boundary surrounding the second opening and a second circular boundary away from the second opening, a diameter of the first circular boundary being smaller than a diameter of the second circular boundary, the first engagement structure being engaged with the second engagement structure to restrict the first engagement structure from moving with respect to the second engagement structure along a lengthwise direction of the shaft.

12. A manufacturing method of a base structure of a cooling fan, the manufacturing method comprising steps of:
providing a bearing defining therein a first cylindrical cavity;
inserting a shaft of the cooling fan into the first cylindrical cavity;
providing a shaft sleeve made of a first material and defining therein a second cylindrical cavity having a first opening and a second opening at a first end and a second end of the shaft sleeve, respectively, the shaft sleeve having:
a protrusion part arranged at the first end of the shaft sleeve and protruding from an inner surface of the shaft sleeve toward the second cylindrical cavity; and
a first engagement structure provided at the second end of the shaft sleeve;
inserting the bearing into the shaft sleeve through the second opening till reaching the protrusion part;
putting the shaft sleeve in a mold to make the first engagement structure of the shaft sleeve located in an accommodation room defined in the mold; and
performing an injection molding process to form a base having a second engagement structure by injecting a second material into the mold, wherein the second engagement structure is interlocked with the first engagement structure since the second engagement structure is integrally formed with the base in the injection molding process, thereby restricting the shaft sleeve from moving with respect to the base.

13. The manufacturing method according to claim 12, wherein the first material has a greater rigidity than the second material.

14. The manufacturing method according to claim 13, wherein the first material is a metal material of copper, aluminum, steel or metal alloy, and the second material is a plastic material.

15. The manufacturing method according to claim 12, wherein the first material has a greater rigidity than the second material when the cooling fan operates and the shaft sleeve is located within a working temperature range of 60-100° C.

16. The manufacturing method according to claim 12, further comprising a step of using an internal turning tool to cut the inner surface of the shaft sleeve at the second end to form an internal annular cutting portion as the first engagement structure, the internal annular cutting portion having an annular slant surface with a first circular boundary surrounding the second opening and a second circular boundary away from the second opening, a diameter of the first circular boundary being smaller than a diameter of the second circular boundary, the first engagement structure being engaged with the second engagement structure to restrict the first engagement structure from moving with respect to the second engagement structure along a lengthwise direction of the shaft.
